(19) United States
(12) Patent Application Publication
(10) Pub. No.: US 2015/0088680 A1
(43) Pub. Date: Mar. 26, 2015

(54) METHODS AND SYSTEMS FOR OPERATING A MARKETPLACE FOR SOFTWARE PRODUCTS

(71) Applicant: Xerox Coporation, Norwalk, CT (US)

(72) Inventors: Sujit Gujar, Bangalore (IN); Tridib Mukherjee, Bangalore (IN); Koustuv Dasgupta, Hebbal (IN)

(73) Assignee: Xerox Coporation, Norwalk, CT (US)

(21) Appl. No.: 14/034,613

(22) Filed: Sep. 24, 2013

(51) Int. Cl. G06Q 20/12; G06Q 30/06; G06Q 30/02

(52) U.S. Cl. CPC G06Q 20/123; G06Q 30/0283; G06Q 30/0645
USPC 705/26.3; 705/26.1; 705/26.35; 705/26.7

(57) ABSTRACT

Methods and systems for operating a marketplace. A first price for one or more financial options associated with one or more software products is determined based on a pre-determined set of factors. The one or more financial options include at least an option of buying to lease the one or more software products. The first price for the one or more financial options associated with the one or more software products is modified based on the one or more financial options opted by one or more users.

### TECHNICAL FIELD

The presently disclosed embodiments are related, in general, to a marketplace. More particularly, the presently disclosed embodiments are related to the marketplace to facilitate buying, renting, and/or leasing of software products.

### BACKGROUND

Marketplace refers to a platform, where users can buy items or services as per their needs. Some of the marketplaces also allow users to sell/buy software products. However, certain users may not require the software product on a permanent basis. Such users may require the software product temporarily to fulfill their requirements. Generally, such kind of scenario leads to piracy, as the users may not want to spend money on the software product, which they do not need on a permanent basis. Furthermore, in such scenarios, the marketplaces may not get revenue proportional to the usage of the software products/services by the users.

### SUMMARY

According to embodiments illustrated herein, there is provided a method implemented in a marketplace server for software products. The method includes determining a first price for one or more financial options associated with one or more software products. The first price is determined based on a pre-determined set of factors. The one or more financial options include at least an option of buying to lease the one or more software products. The method further includes modifying the first price for the one or more financial options associated with the one or more software products based on the one or more financial options opted by one or more users. The method is performed by one or more processors in the marketplace server.

According to embodiments illustrated herein, there is provided a marketplace server for software products including one or more processors operable to determine a first price for one or more financial options associated with one or more software products. The first price is determined based on a pre-determined set of factors. The one or more financial options include at least an option of buying to lease the one or more software products. The one or more processors are further operable to modify the first price for the one or more financial options associated with the one or more software products based on the one or more financial options opted by one or more users.

According to embodiments illustrated herein, there is provided a computer program product for use with a computer. The computer program product includes a non-transitory computer readable medium. The non-transitory computer readable medium stores a computer program code for operating a marketplace for software products. The computer program code is executable by one or more processors to determine a first price for one or more financial options associated with one or more software products. The first price is determined based on a pre-determined set of factors. The one or more financial options include at least an option of buying to lease the one or more software products. The computer program code is further executable by the one or more processors to modify the first price for the one or more financial options associated with the one or more software products based on the one or more financial options opted by one or more users.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 is a block diagram illustrating a system environment in which various embodiments can be implemented;

FIG. 2 is a block diagram illustrating a system for operating a marketplace for software products, in accordance with at least one embodiment; and

FIG. 3 is a flowchart illustrating a method for operating a marketplace for software products, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “at least one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

A “user” refers to a collective term used for buyers, sellers, renters, or leasers, who access a marketplace for buying, selling, renting, or leasing, respectively, software products. In accordance with the disclosed embodiments, the buyer refers to a user of the marketplace who wants to buy the software product. The software product may be bought by the buyer by using an interface provided by the marketplace. In a similar way, seller refers to a user who wants to sell the software product in the marketplace and renter refers to a user who rents the software product from another user (i.e. a leaser). In an embodiment, the users may correspond to peers in a peer-to-peer (P2P) network environment.

A “financial option” refers to one or more options associated with a software product available to the user while using the marketplace. The financial options available to the user may include at least one of buying only, leasing, renting, selling, or buying to lease.

A “buy to lease financial option” refers to the financial option that enables the user to lease out the software product to other users. In an embodiment, the user has an option to buy the software product with buy to lease option such that the user can further lease out the software product to a renter. In an embodiment, the renter and the leaser each pay a pre-determined commission to the marketplace for a successful lease agreement between the renter and the leaser. The commission may be a fixed value or a function of rental value agreed between the renter and the leaser.

A “software product” refers to an application, software, tool, framework, and the like, which the buyer may want to buy and the seller may want to sell on the marketplace. In an embodiment, the software product can be leased to the renter in lieu of a rental, paid by the renter.

A “reputation factor” refers to a score, calculated for each of the users, signifying popularity of the users on the marketplace. In an embodiment, the popularity of the users may be determined based on one or more financial options previously opted by the users, successful rentals happened for the users, and so forth. In an embodiment, a separate reputation factor for the users as the leasers and as the renters is determined.

A “trust index” refers to a score, calculated for each of the users, corresponding to the reputation of the users as the leasers or as the renters. In an embodiment, the trust index is determined based on the separate reputation factors for the users as the leasers and as the renters. The trust index may be one of a guiding factor for the renters to select the leasers from whom to rent the software product.

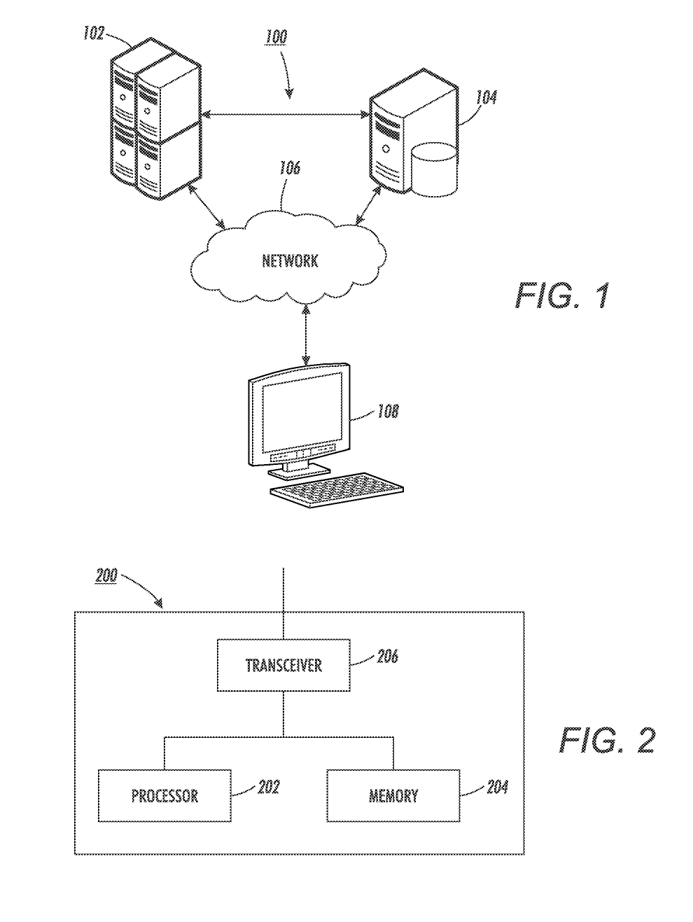

FIG. 1 is a block diagram illustrating a system environment 100, in accordance with at least one embodiment. The system environment 100 includes a marketplace server 102, a database server 104, a network 106, and a computing device 108. The marketplace server 102, the database server 104, and the computing device 108 are interconnected over the network 106.

The marketplace server 102 is capable to host an application/tool/framework for operating the marketplace. The users may access the marketplace server 102 over the network 106 for buying, selling, renting, leasing, or buying to lease software products. In an embodiment, the marketplace server 102 may present a user interface (UI) to the users that enables the users to search for the required software products and make the transaction (e.g., buying, selling, renting, leasing, or buying to lease). The marketplace server 102 may be implemented using one or more known application servers such as, but are not limited to, Java application server, .NET framework, and Base4 application server. Some examples of the marketplace server 102 may include Amazon®, eBay®, Netflix® and so forth. The marketplace server 102 is described later in conjunction with FIG. 2.

The database server 104 may refer to a device or a computer that maintains a repository of software products. In an embodiment, the database server 104 maintains information (e.g., system requirements for the software products, reviews of the software products by other users and so forth) about the software products that may be accessed by the users while buying or renting the software products. The database server 104 may receive a query from the marketplace server 102 to retrieve the information about the software products. For querying the database server 104, the marketplace server 102 may utilize one or more querying languages such as, but are not limited to, SQL, QUEL, DMX and so forth. Further, the database server 104 may be realized through various technologies, such as, but not limited to, Microsoft® SQL server, Oracle, and My SQL. In an embodiment, the marketplace server 102 may connect to the database server 104 using one or more protocols such as, but not limited to, ODBC protocol and JDBC protocol.

A person skilled in the art would understand that the scope of the disclosure should not be limited to the database server 104 as a separate entity. In an embodiment, the functionalities of the marketplace server 102 and the database server 104 may be combined into a single server, without limiting the scope of the disclosure.

The network 106 corresponds to a medium through which content and messages flow between various devices of the system environment 100 (e.g., the marketplace server 102, the database server 104, and the computing device 108). Examples of the network 106 may include, but are not limited to, a Wireless Fidelity (Wi-Fi) network, a Wide Area Network (WAN), a Local Area Network (LAN), or a Metropolitan Area Network (MAN). Various devices in the system environment 100 can connect to the network 106 in accordance with the various wired and wireless communication protocols such as Transmission Control Protocol and Internet Protocol (TCP/IP), User Datagram Protocol (UDP), and 2G, 3G, or 4G communication protocols.

The computing device 108 refers to a computer used by the users to access the marketplace server 102. In an embodiment, the computing device 108 receives the UI from the marketplace server 102 that can be utilized by the users to opt for the one or more financial options associated with the software products. Some of the examples of the computing device 108 may include, but are not limited to, a personal computer, a laptop, a PDA, a mobile device, a tablet, and the like.

FIG. 2 is a block diagram of the marketplace server 102, in accordance with at least one embodiment. The marketplace server 102 includes a processor 202, a memory 204, and a transceiver 206. The marketplace server 102 is described in conjunction with FIG. 1.

The processor 202 is coupled to the memory 204 and the transceiver 206. The processor 202 includes suitable logic, circuitry, and/or interfaces that are operable to execute one or more instructions stored in the memory 204 to perform predetermined operation. The memory 204 may be operable to store the one or more instructions. The processor 202 may be implemented using one or more processor technologies known in the art. Examples of the processor 202 include, but not limited to, an X86 processor, a RISC processor, an ASIC processor, a CISC processor, or any other processor.

The memory 204 stores a set of instructions and data. Some of the commonly known memory implementations include, but are not limited to, a random access memory (RAM), a read only memory (ROM), a hard disk drive (HDD), and a secure digital (SD) card. Further, the memory 204 includes the one or more instructions that are executable by the processor 202 to perform specific operations. It is apparent to a person having ordinary skills in the art that the one or more instructions stored in the memory 204 enables the hardware of the marketplace server 102 to perform the predetermined operation.

The transceiver 206 transmits and receives messages and data to/from various components of the system environment 100 (e.g., the database server 104, and the computing device 108). Examples of the transceiver 206 may include, but are not limited to, an antenna, an Ethernet port, an USB port or any other port that can be configured to receive and transmit data. The transceiver 206 transmits and receives data/messages in accordance with the various communication protocols, such as, TCP/IP, UDP, and 2G, 3G, or 4G communication protocols.

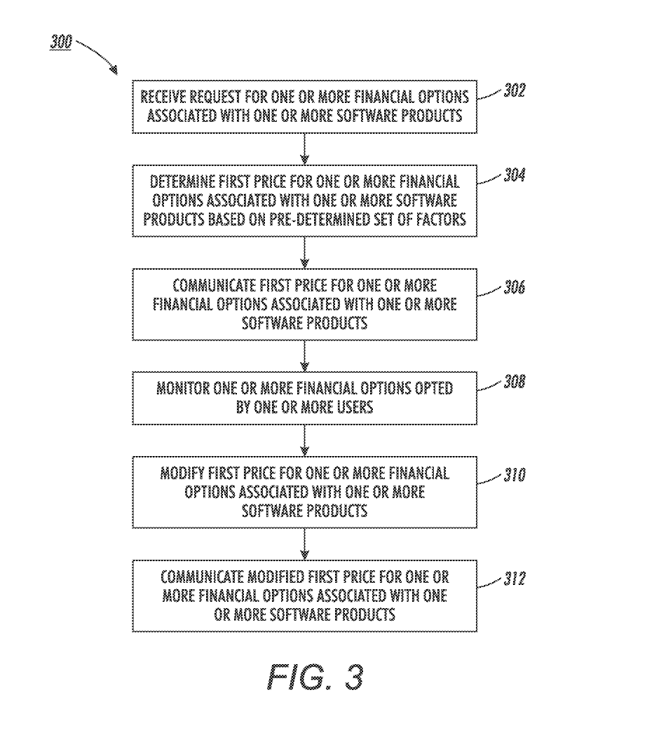

The operation of the marketplace server 102 has been described in conjunction with FIG. 3.

FIG. 3 is a flowchart 300 illustrating a method for operating the marketplace, in accordance with at least one embodiment. The flowchart 300 is described in conjunction with FIG. 1 and FIG. 2.

At step 302, a request for one or more financial options associated with the one or more software products is received by the marketplace server 102. In an embodiment, the processor 202 is operable to receive the request through the transceiver 206. In an embodiment, the one or more users (e.g., buyers, sellers, renters, or leasers) access the marketplace server 102 over the network 106. The processor 202 may present the UI (e.g., through a web interface) to the one or more users to facilitate the buying, selling, renting, leasing, or buying to lease the one or more software products. In an embodiment, the one or more users may run a search query in the UI to search for a software product. The processor 202 of the marketplace server 102, in response to the search query, may fetch the information associated with the one or more software products from the database server 104 over the network 106. In an alternate embodiment, the information may be stored in the memory 204 of the marketplace server 102. Examples of the information corresponding to the one or more software products may include, but are not limited to, system requirements for the software products, reviews of the software products by other users, etc. Along with the information, the processor 202 presents one or more financial options associated with the one or more software products through the UI. The one or more users may use the information to make a decision to opt any of the one or more financial options.

At step 304, the processor 202 determines a first price for each of the one or more financial options associated with each of the one or more software products. The first price may be determined based on a pre-determined set of factors. In an embodiment, the pre-determined set of factors include at least one of following factors:
f_{#r}=probability density function for number of times the renters rent the one or more software products,
n=average number of times the renters rent the one or more software products,
r=average rent paid by the one or more renters for the one or more software products,
N=number of times the one or more leasers with trust index more than 0.5 successfully lease the one or more software products,
Pₗ=minimum price to be charged while selling the one or more software products,
Pₘ=maximum price to be charged while selling the one or more software products,
r₁=minimum possible rent for the one or more software products,
r₂=maximum possible rent for the one or more software products,
c=commission that the marketplace charges from the renters as well as leasers if the one or more software products are rented successfully,
X=price for the software product for the buy only option,
Y=price for the software product for the buy to lease option,
p_{b}=probability that the buyer will opt for the buy only option,
P_{bl}=probability that the buyer will opt for the buy to lease option,
pᵣ=probability that the renter will rent the one or more software products, or
EC=expected commission from the buyer if he opts the buy to lease option.

In an embodiment, Pₗ and Pₘ are determined by market study. f_{#r} may be learned by the processor 202 based on the one or financial options previously opted by the one or more users for each of the one or more software products. In an alternate embodiment, f_{#r} may initially be determined by the market study with a rough estimate and may further be refined, by the processor 202, based on the one or more financial options opted by the one or more users. In an embodiment, n (i.e., average number of times the renters rent the one or more software products) is determined by using f_{#r} or by monitoring a number of times the one or more software products is rented by the one or more users. In an embodiment, there are N transactions after the user opts for the buy to lease option. For example, if the user who opted for the buy to lease financial option and further leased out the software product 10 times to the renters then the value of N will be 10.

In order to determine revenue of the marketplace, the processor 202 determines an expected commission (i.e. EC) from the user by using following equation:

EC=N×2c (1)

Thus, the monetary gain of the marketplace may be determined by processor 202 using following equation:

monetary gain=Xp_{b}+(Y+EC)p_{bl}+2ncpᵣ (2)

In an embodiment, the processor 202, may use below equation to ensure that the monetary gain is maximized:

max{Xp_{b}+(Y+EC)p_{bl}+2ncpᵣ} (3)

In order to maximize the monetary gain, the processor 202 determines the first price for each of the one or more financial options. For renting option, the processor 202 determines a range within which the leasers can bid for their software products. In an embodiment, the processor 202 utilizes following equation to determine the range (r₁ to r₂):

$$\begin{matrix}{r}_{1} = max ( \frac{r}{k} , \frac{{P}_{l}}{kn} ) & ( 4 ) \\ {r}_{2} = min ( 2 r , \frac{{P}_{m}}{2} ) & ( 5 )\end{matrix}$$

where,

k is a constant.

In an embodiment, the range determination may provide better stability in the marketplace such that the bidding price should not be too away from the past average rentals.

Further, the processor 202 determines the first price for buy to lease option. In an embodiment, the first price for the buy to lease option is so determined that the extra price paid by a user to select the buy to lease option is compensated by the expected returns from the rentals. The processor 202 utilizes following equation to determine price for buy to lease option:

Y=X+N(r−c) (6)

Further, the processor 202 determines the first price for the buy only option. In an embodiment, the first price for the buy only option should be so determined that the users do not opt for only renting option or buy to lease option. In order to ensure this, the processor 202 utilizes following condition to determine the first price for the buy only option:

Xε[nr₁,nr₂]∩[Pₗ,Pₘ] (7)

Using equations (1), (3), and (6), the processor 202 maximizes the revenue of the marketplace as follows:

max{Xp_{b}+(X+N(r+c))p_{b}+2ncpᵣ} (8)

In an embodiment, the monetary gain may be maximized by empirically studying p_{b}, p_{bl}, pᵣ, which are functions of X, Y, r, N, n. In an embodiment, to ensure that there is similar likelihood for the users to opt the buying, renting, and buying to lease option, the processor 202 may determine X using heuristic pricing schemes as follows:

X=min(n(r+c),Pₘ) (9)

It would be apparent to a person skilled in the art that the step 302 and the step 304 need not be performed in the same order. In an embodiment, the step 304 may be performed prior to the step 302 (i.e., the processor 202 of the marketplace server 102 may have already determined the first price for the one or more financial options associated with the one or more software products. The first price may subsequently be presented to the user, when the search query from the user is received).

At step 306, the determined first price for one or more financial options is communicated to the computing device 108 over the network 106. In an embodiment, the processor 202 communicates the first price for the one or more financial options through the transceiver 206. In an embodiment, the first price is communicated along with the information associated with the one or more software products. In an embodiment, the one or more users opt for the one or more financial options in response to the reception of the first price.

At step 308, the one or more financial options opted by the one or more users are monitored by the processor 202. In an embodiment, the processor 202 monitors how frequently the one or more users are renting the software products, what are average rentals being agreed upon between the leasers and the renters, how many successful rentals have happened for the one or more leasers, and so forth. The processor 202 is operable to publish these observations to the one or more users through the UI. Further, the processor 202 determines reputation of each user as the renter or the leaser. In an embodiment, the processor 202 determines a reputation factor corresponding to both scenarios (i.e., the user as the leaser and the user as the renter). The processor 202 may further determine a trust index based on the two reputation factors. In an embodiment, a good trust index may be devised by forming the one or more communities of the leasers and the renters based on methods on social community known in the art. The processor 202 is further operable to provide one or more recommendations to the one or more users based on the monitoring. For example, the processor 202 may provide the recommendation of buying a particular software product to a user who is frequently opting for the renting option of the particular software product. In an embodiment, the one or more users may use the bidding prices, the trust index, the published observations, or the recommendations to make a decision to opt for the one or more financial options.

At step 310, the first price for the one or more financial options associated with the one or more software products is modified by the processor 202. As the processor 202 monitors the one or more financial options opted by the one or more users, it dynamically adjusts the first price for the software products such that there remains a similar likelihood for the one or more users to opt for the one or more financial options. The first price for the one or more financial options may be modified by using the equations discussed above, which ensure the similar likelihood for the one or more financial options. In an embodiment, if r goes up, few number of the users will opt renting option, whereas there will be more users who will opt the buy only or buy to lease option. In that case, more leasers will be there in the marketplace and average rentals will come down. When the average rentals are down, more users will prefer to opt renting. Thus, N will increase and the users will prefer to opt for buy only or buy to lease option. As an example, if the first prices determined for a software product for the financial options buy only, rent, and buy to lease are $20, $5, and $25, respectively, and if the processor 202 monitors that most of the users are opting for the renting option, then the first prices for rent only, rent, and buy to lease are modified such that user is more likely to opt for the buy only or buy to lease option.

At step 312, the modified first price for the one or more financial options is communicated to the one or more users. The modified first price is communicated by the processor 202 of the marketplace server 102 over the network 106.

It would be apparent to a person skilled in the art that though the above disclosed embodiments are described with respect to software products, the disclosed embodiment may be applicable for other types of products (e.g., electronic items, books, mobile accessories, and so forth) as well, without limiting the scope of the disclosure.

The disclosed embodiments encompass numerous advantages. In the marketplace where the sellers have an option to lease out the software product, there is less tendency towards creating pirated software products. Further, since the infrequent users have the option to rent the software products, they tend to decrease the use of the pirated software products. In this way, the marketplace gets the revenue proportional to the usage of the software products. In addition, such a marketplace can pave a way for more peer-to-peer service provisioning and consumption in a formal way, thus potentially disrupting cloud-based service hosting. As a result, the users can be prevented from huge prices for the software products amplified by the overhead of maintaining large cloud infrastructures. Typically, such a buy to lease (BLR) software marketplace is free from the disadvantages associated with the marketplaces in other industries (e.g., automobile manufacturing), such as, high reproduction costs of products, continuous depreciation of the products, and running costs associated with the production. Further, whereas in other industries a user purchases the products at discounted prices (e.g., when the user want to lease out the products to other users), in the software marketplace, which offers buy to lease option users need to pay more because of extra rights (i.e., to lease out the software) provided to them. This is profitable to the marketplace server as well as software production houses. In addition, buying to lease option enables the user to earn by leasing out the software products.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for operating a marketplace have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method comprising:
in a marketplace server for software products:
determining, by one or more processors, a first price for one or more financial options associated with one or more software products based on a pre-determined set of factors, wherein the one or more financial options comprise at least an option of buying to lease the one or more software products; and
modifying, by the one or more processors, the first price for the one or more financial options associated with the one or more software products based on the one or more financial options opted by one or more users.

2. The method of claim 1, wherein the one or more financial options further comprise at least one of an option of buying the one or more software products or an option of renting the one or more software products.

3. The method of claim 1, wherein the one or more users correspond to at least one of one or more buyers, one or more sellers, one or more renters, or one or more leasers.

4. The method of claim 3, wherein the pre-determined set of factors comprises at least one of a number of times the one or more renters rent the one or more software products, rent paid by the one or more renters for the one or more software products, a commission paid by the renters and the leasers to a marketplace, a minimum and a maximum price for the one or more software products, or a number of times the one or more leasers lease the one or more software products.

5. The method of claim 3, wherein the one or more leasers bid for the one or more software products with associated bidding price.

6. The method of claim 5 further comprising determining a range for the bidding price based on the pre-determined set of factors.

7. The method of claim 3 further comprising publishing a number of successful rentals for the one or more leasers and associated rental amount.

8. The method of claim 1 further comprising determining a trust index corresponding to the one or more users.

9. The method of claim 1 further comprising providing one or more recommendations to at least one user from the one or more users based on the one or more financial options opted by the at least one user.

10. The method of claim 1, wherein the one or more users correspond to peers in a peer-to-peer (P2P) network environment.

11. A marketplace server for software products comprising:
one or more processors operable to:
determine a first price for one or more financial options associated with one or more software products based on a pre-determined set of factors, wherein the one or more financial options comprise at least an option of buying to lease the one or more software products; and
modify the first price for the one or more financial options associated with the one or more software products based on the one or more financial options opted by one or more users.

12. The system of claim 11, wherein the one or more financial options further comprise at least one of an option of buying the one or more software products or an option of renting the one or more software products.

13. The system of claim 11, wherein the one or more users correspond to at least one of one or more buyers, one or more sellers, one or more renters, or one or more leasers.

14. The system of claim 13, wherein the pre-determined set of factors comprises at least one of a number of times the one or more renters rent the one or more software products, rent paid by the one or more renters for the one or more software products, a commission paid by the renters and the leasers to a marketplace, a minimum and a maximum price for the one or more software products, or a number of times the one or more leasers lease the one or more software products.

15. The system of claim 13, wherein the one or more leasers bid for the one or more software products with associated bidding price.

16. The system of claim 15, wherein the one or more processors are further operable to determine a range for the bidding price based on the pre-determined set of factors.

17. The system of claim 11, wherein the one or more processors are further operable to determine a trust index corresponding to the one or more users.

18. The system of claim 11, wherein the one or more processors are further operable to provide one or more recommendations to at least one user from the one or more users based on the one or more financial options opted by the at least one user.

19. The system of claim 11, wherein the one or more users correspond to peers in a peer-to-peer (P2P) network environment.

20. A computer program product for use with a computer, the computer program product comprising a non-transitory computer readable medium, wherein the non-transitory computer readable medium stores a computer program code for operating a marketplace for software products, the computer program code is executable by one or more processors to:
determine a first price for one or more financial options associated with one or more software products based on a pre-determined set of factors, wherein the one or more financial options comprise at least an option of buying to lease the one or more software products; and
modify the first price for the one or more financial options associated with the one or more software products based on the one or more financial options opted by one or more users.
